(19) United States
(12) Patent Application Publication
(10) Pub. No.: US 2025/0322200 A1
(43) Pub. Date: Oct. 16, 2025

(54) ASSIGNING DATA STRUCTURES TO INSTANCES OF APPLICATIONS USING MACHINE LEARNING

(71) Applicant: State Farm Mutual Automobile Insurance Company, Bloomington, IL (US)

(72) Inventor: Nathan Shepherd, Bloomington, IL (US)

(73) Assignee: State Farm Mutual Automobile Insurance Company, Bloomington, IL (US)

(21) Appl. No.: 18/632,056

(22) Filed: Apr. 10, 2024

(51) Int. Cl. G06N 3/02

(52) U.S. Cl. CPC G06N 3/02

(57) ABSTRACT

Presented herein are systems and methods of assigning policies across application instances using machine learning (ML) models. A computing system of a policy administration system may identify a first data structure of a first policy. The computing system may obtain a first plurality of attributes associated with the first policy. The computing system may apply a ML model to the first data structure and the first plurality of attributes. The ML model may be trained using a plurality of instance assignments. The computing system may assign, from applying the ML model, the first data structure of the first policy to a first application instance from the plurality of application instances of the policy administration system.

### BACKGROUND

In a networked environment, a set of computing clusters may communicate with one another to provide various functionalities. Each computing cluster may include a group of interconnected computers (e.g., in the form of servers or virtual machines). Load balancing mechanisms may be used across the set of computing clusters as well as within each computing cluster to facilitate the provision of services. There may a number of challenges in effectively performing load balancing. For example, the assignment of the load on each computing cluster may be dynamic and may be subject to sudden changes for the services. These abrupt changes can negatively impact how the related hardware may perform, leading to difficulties or inability to access the services hosted on the computing cluster.

### SUMMARY

Aspects of the present disclosure are directed to systems, methods, and non-transitory computer readable media for assigning policies across application instances using machine learning (ML) models. One or more processors of a policy administration system may identify a first data structure of a first policy. The one or more processors may obtain a first plurality of attributes associated with the first policy. The one or more processors may apply a ML model to the first data structure and the first plurality of attributes. The ML model may be trained using a plurality of instance assignments. Each of the plurality of instance assignments may identify (i) a second data structure of a second policy, (ii) a second plurality of attributes, and (iii) a respective application instance selected from a plurality of application instances based on the second data structure and the second plurality of attributes. The one or more processors may assign, from applying the ML model, the first data structure of the first policy to a first application instance from the plurality of application instances of the policy administration system.

In some embodiments, the one or more processors may determine a performance metric of the first application instance based on a volume of data structures assigned to the first application instance. The one or more processors may allocate, based on the performance metric, hardware resources to the first application instance to process the first data structure.

In some embodiments, the one or more processors may identify, for each of the plurality of application instances, a first transaction log of activity over a first time period. The one or more processors may apply the ML model to the first transaction log for each of the plurality of application instances. Each of the plurality of instance assignments may identify, for each corresponding application instance of the plurality of application instances, (i) a respective second transaction log over a second time period and (ii) a respective performance metric identifying a volume of activity subsequent to the second time period. The one or more processors may select the first application instance from the plurality of application instances based on a performance metric determined for the first application instance.

In some embodiments, the one or more processors may receive, from a data source, an indication of an environmental event associated with a first location indicated in the first data structure of the first policy. The one or more processors may apply the ML model to the indication of the environmental event. The one or more processors may assign the first data structure to the first application instance associated with at least one of the first location or a second location.

In some embodiments, the one or more processors may identify the first data structure assigned to a second application instance of the plurality application instances, responsive to an indication to change assignment. The one or more processors may reassign the first data structure of the first policy from the second application instance to the first application instance.

In some embodiments, the one or more processors may retrain the ML model using a second plurality of instance assignments, wherein the second plurality of instance assignments identifies at least one reassignment of a third data structure of a third policy from a second application instance to a third application instance of the plurality of application instances. In some embodiments, the one or more processors may identify the first plurality of attributes including an agent assigned to handle the first policy defined by the first data structure. The one or more processors may assign the first data structure of the first policy to the first application instance associated with the agent.

In some embodiments, the one or more processors may receive, from a computing device associated with an agent, a request to access at least one of the plurality of application instances. The one or more processors may assign, responsive to receiving the request, the computing device to the first application instance based on the request. The one or more processors may provide, via an interface of the first application instance, information associated with the first policy defined by the first data structure.

In some embodiments, the first application instance may process a claim data from a holder associated with the first policy, in accordance with a condition identified by the first policy. In some embodiments, each of the plurality of application instances may be supported by at least one of a respective on-premises system or a respective cloud service.

### BRIEF DESCRIPTION OF THE DRAWINGS

The accompanying drawings constitute a part of this specification, illustrate an embodiment, and together with the specification, explain the subject matter of the disclosure.

FIG. 1 depicts a block diagram of a system for assigning policies across application instances using machine learning (ML) models, in accordance with an illustrative embodiment.

FIG. 2 depicts a block diagram of a process to collect data in the system for assigning policies across application instances, in accordance with an illustrative embodiment.

FIG. 3 depicts a block diagram of a process to training a machine learning model in the system for assigning policies across application instances, in accordance with an illustrative embodiment.

FIG. 4 depicts a block diagram of a process to apply a machine learning model in the system for assigning policies across application instances, in accordance with an illustrative embodiment.

FIG. 5 depicts a flow diagram of a method assigning policies across application instances using machine learning (ML) models, in accordance with an illustrative embodiment.

FIG. 6 is a block diagram of a computing environment according to an example implementation of the present disclosure.

### DETAILED DESCRIPTION

Following below are more detailed descriptions of various concepts related to, and embodiments of, systems and methods for assigning data structures of policies across application instances using machine learning. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes systems and methods for assigning policies across application instances using machine learning models.

Section B describes a describes a network environment and computing environment which may be useful for practicing various embodiments described herein.

### A. Systems and Methods of Assigning Policies Across Application Instances Using Machine Learning Models

A policy administration application may manage large volumes of data related to insurance policies. The data structure for the insurance policy may include entries (e.g., in the form of field-value pairs) identifying an insurer and a holder and defining conditions under which the insurer is to cover the losses incurred by the holder. An instance of the policy administration application may be supported by or hosted or executed on one or more computing devices, such as on a computing cluster (e.g., on-premises, server farm, or cloud computing). Each cluster may include a group of computing devices on which a respective instance of the policy administration application can be installed and executed. In some implementations, the different computing devices and/or computing clusters may be associated with different insurance agent entities (e.g., such that some agents are assigned to or correlated with one device/cluster and other agents are assigned to or correlated with a different device/cluster). A policy management integrator may distribute insurance policy-related data across instances of the policy administration application (e.g., other instances running on other computing devices or clusters of computing devices).

Under one approach, the distribution of the insurance policy-related data may be performed using hard-coded rules. The rule may specify that insurance policy-related data are to be distributed by the policy management integrator to computing clusters based on geographic location. For example, the policy management integrator may distribute insurance-related data for Illinois to a cluster located in Illinois. These rules may be simplistic only factoring in few factors, such as location, and hard-coded, only can be modified by manual updates. As a result, the distribution of the data may be uneven and may not take into account loads faced by the instances of the policy administration application, leading to degradation of performance of individual instances and computing clusters.

To address these and other challenges, the policy management integrator may use a machine learning model to determine at which time and to which an application instance to assign insurance policies and related data. Each application instance may be implemented using one or more computing devices, including, but not limited to, computing clusters (e.g., on-premises, server farm, or cloud computing). For example, each application instance may be associated with or may provide services on behalf of a corresponding insurance agent entity. The application instance may be an instance of the policy administration software running on one of the computing clusters (e.g., corresponding to a group of computing devices). The machine learning model may be trained to assign polices based on complex and dynamic factors. These factors may be related to the insurance policy itself and may include, for example, a location of the policy holder, a policy holder type (e.g., individual or business), dwelling type, vehicle type, risk type, disaster type, coverage type, among others. The factors may also be related to the application instances, such as volume of assigned policies, availability, performance, hardware resources, and network resources, among others. Other factors may also be used, such as weather or environmental events impacting policies. The machine learning model may be trained in accordance with any number of techniques, such as supervised learning. The training data may include the factors and an annotation of the application instance to which the insurance policy is to be assigned.

With the training and establishment of the machine learning model, the policy management integrator may dynamically adjust assignment of insurance policies to different application instances. For instance, the policy management integrator may use the machine learning model to assign the insurance policy by performance, such as if one application instance is experiencing reduced performance due to a high number of assigned insurance policies. The policy management integrator may adjust the assignment to avoid the performance-impacted instance. By using a multitude of different factors, the machine learning model may also be able to output assignments that are optimal for the given input. For example, one of the factors related to the policy may indicate that the policy holder is located in Illinois. The policy management integrator may apply the machine learning model to identify a application instance based in Ohio, as the application instance there may be the most proximate and highest available capacity to process the data, or may balance geographic proximity to the policy holder and processing capacity (e.g., such that the application instance based in Ohio may be selected even though an application instance based in Indiana may be closer to the policy holder but has lower processing capacity than the application instance in Ohio).

In addition, the policy management integrator may allocate hardware resources to application instances based on performance behaviors, in conjunction with the assignment of insurance policies to the application instances. For instance, when one application instance is facing a high volume of insurance policy-related data, the policy management integrator may allocate additional hardware resource to aid in the processing of the policy-related data. In addition, the policy management integrator can use predicted trends in loads to distribute and assign data to different application instances. For example, even if a given application instance is currently experiencing poor performance, the policy management integrator may use the machine learning model to predict that the application instance will face higher load constraints and may assign incoming data to other application instances to be handled by the instances hosted there.

By adjusting the assignments of policies, the policy management integrator may distribute data related to insurance policies across multiple application instances to perform load balancing based on a multitude of factors. In comparison to the rule-based approach, the policy management integrator may use the machine learning model may be able to dynamically and adaptively select application instances based on predicted load. This may improve the distribution of loads across the application instances, thereby improving the performance (e.g., in terms of processor usage, memory consumption, and response time) of the overall set of computing clusters. Leveraging on the myriad of factors such as the risk type and environmental events, the policy management integrator may be able to predict sudden changes (e.g., spikes or drops) in load for the application instance, not just based on performance instrumented from the computing cluster. Furthermore, with the dynamic allocation of hardware resources, the policy management integrator may improve scalability to handle higher volumes of insurance-related data.

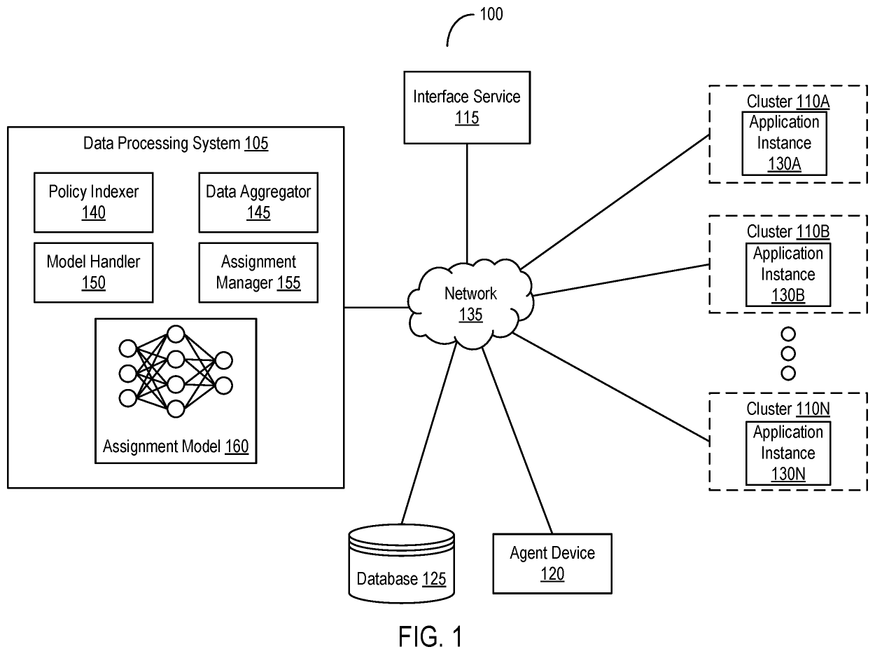

Referring now to FIG. 1, depicted is a block diagram of a system 100 for assigning policies across application instances using machine learning (ML) models. In overview, the system 100 may include at least one data processing system 105, one or more clusters 110A-N (hereinafter generally referred to as clusters 110), at least one interface service 115, at least one agent device 120, and at least one database 125, among others, communicatively coupled with at least one network 135. Each cluster 110 may include at least one application instance 130A-N (hereinafter generally referred to as application instances 130), among others. The data processing system 105 may include at least one policy indexer 140, at least one data aggregator 145, at least one model handler 150, at least one assignment manager 155, and at least one assignment model 160, among others. Each of the components in the system 100 as detailed herein may be implemented using hardware (e.g., one or more processors coupled with memory), or a combination of hardware and software as detailed herein in Section B. While various implementations of the present disclosure discuss application instances being hosted on or otherwise supported by clusters (computing clusters), it should be understood that, in various embodiments, an application instance may be hosted on/supported by a single computing device or any arrangement/configuration/combination of computing devices, and all such modifications are contemplated within the scope of the present disclosure.

In further detail, the data processing system 105 (sometimes herein generally referred to as a policy administration system or policy management integrator) may be any computing device including one or more processors coupled with memory and software and capable of performing the various processes and tasks described herein. In some embodiments, the data processing system 105 may be operated by or associated with a policy administrator entity responsible for distribution of polices across agent entities, the clusters 110, and application instances 130 associated with agent entities. The data processing system 105 may be in communication with the clusters 110 (including the individual application instances 130), the interface service 115, the agent device 120, and the database 125, among others. The data processing system 105 may be situated, located, or otherwise associated with at least one server group. The server group may correspond to a data center, a branch office, or a site at which one or more servers corresponding to the data processing system 105 are situated.

Within the data processing system 105, the policy indexer 140 may identify data structures of policies to be assigned to one of the application instances 130. The data aggregator 145 may obtain data and attributes associated with the data structure of the policy to be used in determining the assignment. The model handler 150 may establish the assignment model 160 using training data (e.g., expected assignments of data structures to application instances 130) and may apply the obtained data to the assignment model 160 to generate assignments identifying selected application instances 130. The assignment manager 155 may provide instructions to assign the data structure of the policy to the selected application instance 130.

The assignment model 160 may be any type of artificial intelligence (AI) algorithm or model, such as an artificial neural network (ANN) (e.g., convolutional neural network (CNN)), a regression model (e.g., linear or logistic), a support vector machine (SVM), random forests, a Bayes network, or a clustering model (e.g., k-means clustering), among others. In general, the assignment model 160 may have a set of inputs and a set of outputs. The assignment model 160 may include a set of weights in accordance with the architecture of the model. The set of weights may represent, define, or otherwise correspond to a relationship between the inputs and outputs of the assignment model 160. The set of inputs may include data related to the data structure of the policy. The set of outputs may include predicted measures of performance of the application instances 130 and the assignments of the data structures of policies to the application instances 130.

Each cluster 110 may correspond to or include a set of computing devices. Each computing device may include one or more processors coupled with memory and software and capable of performing the various processes and tasks described herein. The set of clusters 110 and the respective application instances 130 may be associated with the policy administration system. In some embodiments, the cluster 110 may include a set of virtual machines corresponding to the set of computing devise. Each virtual machine may be hosted on physical hardware (e.g., one or more hardware processors coupled with memory). The computer devices for each cluster 110 may reside or be situated at a defined geographical location. For instance, one cluster 110 may be located in “Town A” in Illinois and another cluster 110 may be present in “City X” in Virginia.

In some embodiments, at least one of the clusters 110 may correspond to an on-premises system. For example, the on-premises system may include a data center associated with the policy administrator or the agent entity for handling insurance claims. In some embodiments, at least one of the clusters 110 may correspond to a cloud service. The service model for the cloud service may be, for example, an infrastructure as a service (IaaS), a platform as a service (PaaS), or a software as a service (SaaS), among others. For instance, the cluster 110 may correspond to the cloud service associated with a third-party service provider managing and supporting the computing devices on behalf of the policy administrator or the agent entity.

Within each cluster 110, the application instance 130 may be an instance of an application (also referred to herein as a policy administration application) running on at least one of the computing devices in the cluster 110. The application instance 130 may correspond to, may be, or may include an executable program to be read, run, and provided by the computing device of the cluster 110. For example, the application instance 130 can be an instance of an application (e.g., a first-party or a third-party application) to administer insurance policies, such as Guidewire's PolicyCenter™, Ventiv Policy™, Oracle Insurance Policy Administration™, or InsPro Enterprise™, among others. The policy administration application can be used to intake insurance submissions, process forms associated with the insurance submission, evaluate risks of application, and provide user interface for managing data associated with the insurance policy, among many other functionalities.

In some embodiments, the application instance 130 may correspond to or may include an instantiation of a virtualization of the application provided through a virtual machine. For example, the application instance 130 may be an instance of the policy administration application can be run on a cloud computing system, such as an Amazon Web Services (AWS) or Microsoft Azure™, among others. In some embodiments, the application corresponding to the application instance 130 may be accessed and used by an agent entity. In some embodiments, the application may manage data related to insurance policies. In some embodiments, the application may handle insurance claims in accordance with the specifications of the associated policy. For instance, upon the submission of an insurance claim by a holder, an agent entity may use the application to process the insurance claim according to the conditions of the policy defined by the data structure for the policy.

The application instances 130 may be supported by or hosted on at least one of the clusters 110. At least one application instance 130 may be supported by or hosted on the on-premises system. For example, when the application instance 130 resides in the cluster 110 corresponding to an on-premises system, the application instance 130 may be supported by a computing device on the on-premises system. At least one application instance 130 may be supported by or hosted on the cloud service. For instance, when the application instance 130 is accessed from the cloud service, the application instance 130 may correspond to a virtual machine providing the application hosted on the physical hardware resources. Each application instance 130 may be in communication with the data processing system 105, the interface service 115, the agent device 120, and the database 125, among others. In some embodiments, the set of application instance 130 can be bound or associated with the database 125. For example, each application instance 130 across the set of clusters 110 can access the database 125 to store, maintain, or edit the data thereon.

In some embodiments, different clusters 119 may have different databases that hold records for different sets of insurance policies. The databases may be similar to the database 125. For example, an insurance company that provides a large number of insurance policies to its customers may store policy data for different sets of insurance policies in distinct databases of two clusters 110, three clusters 110, four clusters 110, five clusters 110, or any other number of clusters 110. In some examples, if the storage space allocated to a database of one cluster becomes full or becomes filled to above a threshold level, a new instance of the policy management system with a new and separate database can be spun up or created with respect to a new cluster, such that more storage space for policy data becomes available in the new cluster.

Elements in one cluster 110 may be at least partially isolated from elements in other clusters 110. For example, the application instance 130 and/or a database in one cluster may not be in direct communication with other application instance 130 and/or a database in other clusters 110. Accordingly, policy data stored in the database of one cluster may not be directly accessible by application instance 130 in other clusters. As an example, the first cluster 110A may include one or more application instances 130A in communication with a local database. The second cluster 110B may similarly include one or more instances of application instances 130B in communication with a local database. In this example, the database in the first cluster 110A may store records for a first set of insurance policies, while the second database may store records for a second set of insurance policies. Accordingly, the application instance 130A in the first cluster 110A may not have access to information about the second set of insurance policies stored in the database of the second cluster 110B. Similarly, the application instance 130B in the second cluster 110B may not have access to information about the first set of insurance policies stored in the database of the first cluster 110A.

The interface service 115 may be any computing device including one or more processors coupled with memory and software and capable of performing the various processes and tasks described here. The interface service 115 may be operated by or associated with an entity for handling communications between the data processing system 105 and the clusters 110. In some embodiments, the interface service 115 may be operated by or associated with another entity different from the policy administrator associated with the data processing system 105. The interface service 115 may facilitate communications among the data processing system 105, the clusters 110, and the agent device 120 via the network 135. For example, when the agent device 120 requests to be assigned one of the application instances 130, the interface service 115 may identify and select an application instance 130 from one of the clusters 110 to provide to the agent device 120. The interface service 115 may also provide the agent entity access to the virtual machine or computer device running the application instance 130. In some embodiments, the functionalities ascribed to the interface service 115 may be performed on the data processing system 105.

The agent device 120 (sometimes herein referred to as a computing device or a client) may be any computing device including one or more processors coupled with memory and software and capable of performing the various processes and tasks described here. In some embodiments, the agent device 120 may be operated by or associated with an agent entity for handling insurance of policy holders. The agent device 120 may be in communication with the data processing system 105, the clusters 110 (including the application instances 130), the interface service 115, and the database 125, among others. The agent device 120 may access one of the application instances 130 in one of the clusters 110 through the data processing system 105 and the interface service 115. For instance, upon request, the agent device 120 may be provided (e.g., by the interface service 115) a session with the assigned application instance 130. Using the agent device 120, the agent entity may interact with the user interface elements of the application instance 130 presented via the display.

The database 125 may store and maintain various resources and data associated with the data processing system 105. The database 125 may include a database management system (DBMS) to arrange and organize the data maintained thereon. The database 125 may be in communication with the data processing system 105, the clusters 110, the interface service 115, and the database 125, among others. The database 125 can interface with the set of application instances 130 via the interface service 115 to store, maintain, and manage policy related data for the policy administration software. For example, the database 125 can store and maintain the policy data using an identifier referencing a respective policy. In some embodiments, the database 125 may be managed by the interface service 115, and communications among the data processing system 105, the clusters 110, and the database 125 may be managed by the interface service 115. While running various operations, the data processing system 105 and the clusters 110 including the application instances 130 may access the database 125 to retrieve various data therefrom and to write new data thereto.

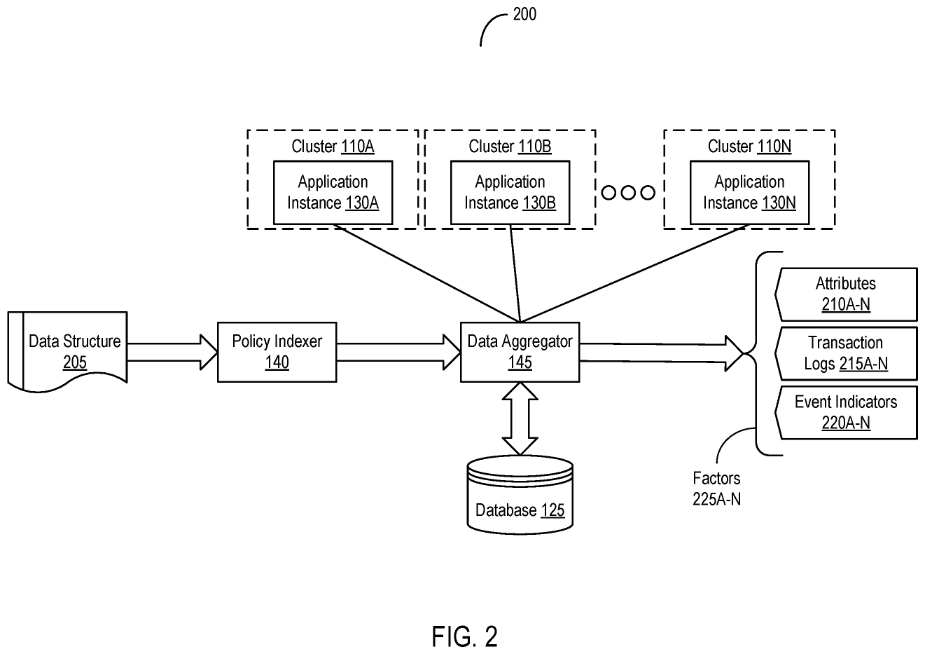

Referring now to FIG. 2, depicted is a block diagram of a process 200 to collect data in the system 100 for assigning policies across application instances. The process 200 may include or correspond to operations performed in the system 100 to identify data structures of policies to be assigned and collect associated data to be used in determining the assignment. Under the process 200, the policy indexer 140 executing on the data processing system 105 may retrieve, obtain, or otherwise identify at least one data structure 205. The data structure 205 may identify, specify, or otherwise define any item of data. For example, the data structure 205 may define data for a policy (e.g., address of customer, garage location, system location, claim data, and payor identification), a policy for handling claims, a request to access (e.g., read, write, or edit) data related to an insurance policy, or incident report, among others. In some embodiments, the policy indexer 140 may access the database 125 to retrieve, fetch, or otherwise identify the data structure 205 from the database 125. The data structure 205 may be stored and maintained on the database 125, along with other data structures of other policies.

The data structure 205 may be in accordance with type of structure, such as an array, a linked list, a stack, a queue, a tree, a graph, a hash table, a heap, or a tree, among others. In some embodiments, the data structure 205 may identify or include one or more data elements (e.g., field-value pairs) defining the corresponding policy. For example, the data structure 205 may identify at least one of: an issuer providing the policy, a holder of the policy (e.g., an individual, a household, a company, or any other entity), an agent associated with the issuer, a type of insurance (e.g., flood, fire, health, home, renter, umbrella, life, travel, disability, pet, boat, or vehicle insurance), an asset under the insurance (e.g., a house, building, vehicle, boat, or pet), a location of the policy holder (e.g., a physical address to a residence or a driver), a location of each asset (e.g., a physical address for a parking garage) and one or more conditions (e.g., for the insurance claims) under which a value is to be transferred from the issuer to the holder of the policy, among others.

In some embodiments, the data structure 205 may include one or more data elements. For example, the data structure 205 may identify at least one of a holder of a policy, an identifier for the policy, an indication of an incident, a documentation of the incident (e.g., images, audio, or textual content), an estimate of costs, and additional information, among others. In some embodiments, the data structure 205 may include one or more data elements defining the incident report. For instance, the data structure 205 may identify at least one of a date and time of an incident, an identification of a type of incident or accident, an identification of involved parties, a documentation of the incident (e.g., images, audio, or textual records), a type of injury, or an identification of a reviewing authority (e.g., policy agent, fireman, clinician, or insurance agent), among others.

In some embodiments, the policy indexer 140 may store and maintain the data structure 205 on the database 125 using an identifier. The identifier may include a set of alphanumeric characteristics or numerical value to uniquely reference the data structure 205 on the database 125. For example, when the data structure 205 defines a policy, the policy indexer 140 may generate a policy identifier to reference the data structure 205. While various implementations of the present disclosure discuss data structures 205 as defining a policy, it should be understood that, in various embodiments, the data structure 205 may define other forms of information, and all such modifications are contemplated to be within the scope of the present disclosure.

In some embodiments, the policy indexer 140 may retrieve, identify, or otherwise receive a request to assign the data structure 205 to one of the application instances 130. In some embodiments, the policy indexer 140 may receive the request to assign from the agent device 120. For instance, an agent entity may use an interface on the agent device 120 to enter specifications for a new policy. The interface may be a graphical user interface of an application interfacing with the data processing system 105 (or the interface service 115). Upon submission, the agent device 120 may generate the data structure 205 defining the new policy and may transmit the request to assign to the data processing system 105. The request may include the data entered via the agent device 120. With receipt, the policy indexer 140 may parse or process the request to extract or identify the data structure 205. The policy indexer 140 may generate the policy identifier corresponding to the data structure 205 and store the data structure from the request onto the database 125.

In some embodiments, the policy indexer 140 may receive the request to assign from an end-user device associated with the holder for the policy. For example, a holder using the end-user device may use an interface to enter specifications for a new policy. The end-user device may transmit the data for the new policy and the request to assign to the data processing system 105. With receipt, the policy indexer 140 may parse or process the request to extract or identify the data and may use the data to form or generate the data structure 205 for the new policy. The policy indexer 140 may generate the policy identifier corresponding to the data structure 205 and store the data structure from the request onto the database 125.

In some embodiments, the policy indexer 140 may monitor or check for an indication to reassign at least one of the data structures 205. In some embodiments, the policy indexer 140 may retrieve, identify, or otherwise receive the indication to reassign from at least one of the application instances 130 of one of the clusters 110. The indication may identify (e.g., using the policy identifier) at least one data structure 205 to be reassigned. The data structure 205 may be initially assigned to the application instance 130. The indication may correspond to, for example, a detection of a fault, a notification of a shutting down, or otherwise in ability to handle additional policies from the impacted application instance 130 or cluster 110. With receipt, the policy indexer 140 may store an association between the data structure 205 and the indication to reassign on the database 125.

The data aggregator 145 executing on the data processing system 105 may retrieve, identify, or otherwise obtain data (sometimes herein referred to as factors) with which to assign the data structure 205. With the identification of the data structure 205 of the policy, the data aggregator 145 may generate, determine, or otherwise identify a set of attributes 210A-N (hereinafter generally referred to as attributes 210) associated with the data structure 205. Each attribute 210 may define or identify a property or value to be used in assigning the data structure 205. For example, the set of attributes 210 may include or identify a location associated with the holder of the policy (e.g., residence address or geographic location of the request), a location of a covered asset (e.g., a geographic location), a type of policy holder (e.g., an individual or a business), a type of insurance (e.g., flood, fire, vehicle, or housing insurance), a type of insured asset (e.g., vehicle or house), a type of risk or disaster, an agent assigned to handle claims for the policy, or a coverage type, among others. The set of attributes 210 may be identified by the data aggregator 145 from the data structure 205 itself or from other sources. The data aggregator 145 may retrieve the attributes 210 from any number of data sources, such as the database 125, the agent device 120, the end-user devices, or the application instance 130, among others.

In addition, the data aggregator 145 may retrieve, obtain, or otherwise identify a set of transaction logs 215A-N (hereinafter generally referred to as transaction logs 215) for corresponding application instances 130 (or the clusters 110). The set of transaction logs 215 may be maintained on the application instances 130 themselves, the clusters 110, the interface service 115, or the database 125, among others. Each transaction log 215 may identify a record of activities performed by the corresponding application instance 130 over a period of time. Each activity may correspond to a function call (e.g., accessing data or performance of an action) invoked on the application instance 130 and may be identified by a time stamp indicating a time at which the activity is invoked. The period of time may be defined relative to a time at which the transaction log 215 is obtained. For example, the period of time may range between 30 minutes to 1 month from the present. In some embodiments, the transaction log 215 may include or identify an amount of load on the application instance 130 over the period of time. The load may correspond to utilization of resources, such as processor usage, memory usage, a number of functions, and network throughput, among others. The amount of load may be measured at a sampling interval (e.g., ranging from 1 seconds to 10 minutes) over the period of time.

The data aggregator 145 may also retrieve, identify, or otherwise receive one or more event indicators 220A-N (hereinafter generally referred to as event indicators 220). In some embodiments, the data aggregator 145 may monitor or check for the event indicators 220 from one or more data sources. In some embodiments, the data aggregator 145 may retrieve the event indicators 220 from the one or more data sources, in response to the identification of the data structure 205. Each event indicator 220 may correspond to or identify an occurrence of an event, such as an environment event or weather-related event, among others. For instance, the data aggregator 145 may receive the event indicator 220 corresponding to a hurricane from a meteorological service. The event indicator 220 may include information about the event, such as a type of event (e.g., earthquake, fire, flood, hail, hurricane, rain, tornado, snowstorm, and volcano), a severity of the event (e.g., Richter scale, amount of rain, amount of snowfall, and hurricane strength), and impacted location (e.g., geographic area), among others. In some embodiments, the data aggregator 145 may select one or more of the event indicators 220 based on the data structure 205 of the policy. For example, the data aggregator 145 may identify the policy for the data structure 205 as for flood insurance and may select the event indicators 220 related to flood, such as an indication of rain, flood, or hurricane, among others.

The data aggregator 145 may collect, arrange, or otherwise package one or more of the set of attributes 210, the transaction logs 215, and the event indicators 220. The set of attributes 210, the transaction logs 215, and the event indicators 220 may form a set of factors to be applied to the assignment model 160 to assign the data structure 205 to one of the application instances 130. In some embodiments, the input in the request (e.g., from the agent device 120 or the end-user device) may also be part of the set of factors to be applied to the assignment model 160.

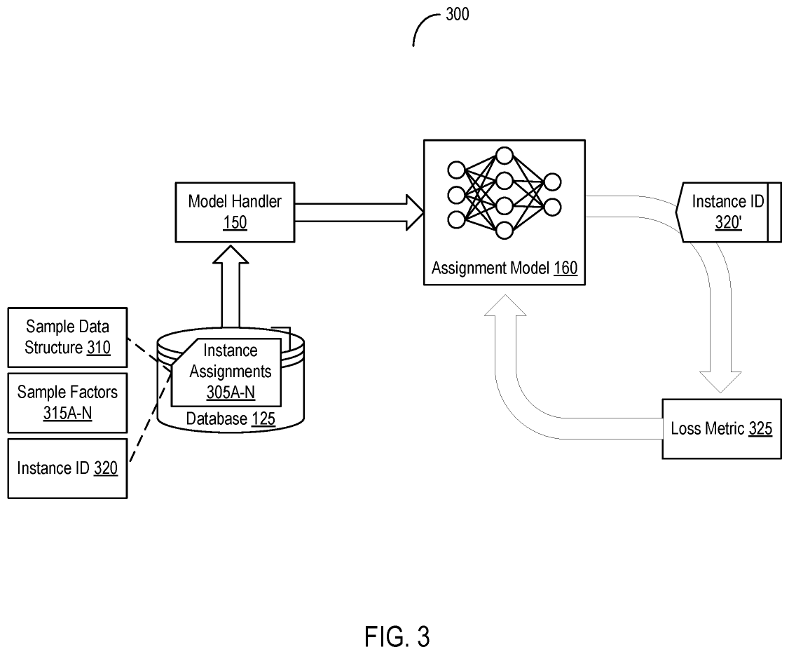

FIG. 3 depicts a block diagram of a process to training a machine learning model in the system for assigning policies across application instances. The process 300 may include or correspond to operations performed in the system 100 for establishing the assignment model 160. The model handler 150 executing on the data processing system 105 may initialize, train, and establish the assignment model 160 using a set of instance assignments 305A-N (hereinafter generally referred to as instance assignments 305). The assignment model 160 may be of any model architecture, such as a deep learning model, a clustering model, or a generative transformer model, among others. The initialization, training, and establishment of the assignment model 160 may be performed prior to application of the assignment model 160 to the new input identified in process 200. The set of instance assignments 305 may be used as training dataset for the assignment model 160. The model handler 150 may construct, create, or otherwise initialize the assignment model 160 with values for the set of weights (e.g., initial random values).

To train the assignment model 160, the model handler 150 may access the database 125 to fetch, retrieve, or otherwise identify the set of instance assignments 305. The set of instance assignments 305 may be aggregated or collected over a period of time (e.g., ranging from 5 minutes to 3 months relative to time of identification). Each instance assignment 305 may correspond to an example identifying inputs and expected outputs for the assignment model 160. Each instance assignment 305 may identify or include at least one sample data structure 310. The sample data structure 310 may be of a similar form as the data structure 205. The sample data structure 310 may, for example, include one or more data elements defining a corresponding policy and may identify at least one issuer providing the policy, a holder of the policy, an agent associated with the issuer, a type of insurance, an asset under the insurance, and one or more conditions under which a value is to be transferred from the issuer to the holder of the policy, among others.

In addition, each instance assignment 305 may also identify or include a set of sample factors 315A-N (sometimes herein referred to as the set of sample factors 315). The set of sample factors 315 may include, for example, any one of the attributes associated with the sample data structure 310 (e.g., similar to the attributes 210), a transaction log for each application instance 130 over a period of time (e.g., similar to the transaction logs 215), or event indicators (e.g., similar to the event indicators 220), among others. Each instance assignment 305 may also identify or include at least one instance identifier 320 corresponding to the application instance 130 to which the sample data structure 310 is expected to be assigned. The instance identifier 320 may also identify the cluster 110 in which the application instance 130 resides.

In some embodiments, each instance assignment 305 may identify or include a measured performance metric identifying a volume of activity for each application instance 130 subsequent to the period of time for the activity log. The performance metric may also include or identify a resiliency, outage duration, outage frequency, or a reboot speed, among others, for each application instance 130. The performance of the application instance 130 may be one metric used to measure which policy is applied to which application instance 130. Other data may include policy (or account) relationship to adjacent or related policies related to another policy. Examples of related policy may include, for example: drivers, storage locations, policy owners, Insurance Agents, among others. In some embodiments, each instance assignment 305 may include assignment alignment, such as storage location or prior agent location, among others. An example of data may include location of such policy to storage location (e.g., corresponding to the database 125). For instance, an east coast policy may align to application hosted on east coast to reduce transaction time.

The model handler 150 may traverse through the set of instance assignments 305. For each instance assignment 305, the model handler 150 may apply the assignment model 160 to the sample data structure 310 and at least a portion of the set of sample factors 315 (e.g., the set of attributes, the transaction log, or the event indicators, or any combination thereof). In applying, the model handler 150 may input or feed the sample data structure 310 and the set of sample factors 315 to the assignment model 160. Upon feeding, the model handler 150 may process the input sample data structure 310 and at least the portion of the set of sample factors 315 in accordance with the set of weights of the assignment model 160.

From processing, the model handler 150 may create, produce, or otherwise generate an output including a predicted instance identifier 320′ corresponding to at least one of the application instances 130. In some embodiments, the output may include at least one predicted performance metric. In some embodiments, the output may include a set of instance identifiers 320′ for the corresponding set of application instances 130. The set of instance identifiers 320′ may be ranked by the respective predicted performance metrics. In some embodiments, the output text may also include the predicted performance metric for the application instance 130.

With the generation of the output, the model handler 150 may compare the predicted instance identifier 320′ with the expected instance identifier 320 identified in the instance assignment 305. In some embodiments, the model handler 150 may compare the predicted performance metric with the expected performance metric. Based on the comparison, the model handler 150 may calculate, generate, or otherwise determine at least one loss metric 325. The loss metric 325 may indicate a degree of deviation of the output from the expected output as defined by the instance assignment 305. The loss metric 325 may be calculated in accordance with any number of loss functions, such as a norm loss (e.g., L1 or L2), mean squared error (MSE), quadratic loss, cross-entropy loss, or Huber loss, among others.

Using the loss metric 325, the model handler 150 may modify, change, or otherwise update at least one weight of the assignment model 160. The updating of the weights may be in accordance with architecture or algorithm for the assignment model 160. The updating of weights of the assignment model 160 may be in accordance with an optimization function (also referred to herein as an objective function). The optimization function may define one or more rates or parameters at which the weights of the assignment model 160 are to be updated. The optimization function may be in accordance with stochastic gradient descent, and may include, for example, an adaptive moment estimation (ADAM), implicit stochastic gradient descent (ISGD), and adaptive gradient algorithm (AdaGrad), among others. The updating of the weights of the assignment model 160 may be repeated until convergence. Upon completion of training, the model handler 150 may store and maintain the set of weights of the assignment model 160 on the database 125 to be used to generate new outputs. By training, the assignment model 160 may be trained to deduce and identify patterns, correlations, and latent features that are not expressly labeled in the set of instance assignments 305 used as the training data.

In some embodiments, the model handler 150 may retrain the assignment model 160 using another set of instance assignments 305. To retrain, the model handler 150 may access the database 125 to identify the instance assignments 305. The set of instance assignments 305 may be collected over another period of time and may be subsequent to the initial set of instance assignments 305 used to initialize, train, and establish the assignment model 160. The new set of instance assignments 305 may include at least one reassignment of the sample data structure 310 from one application instance 130 to another application instance 130. For example, during runtime, the agent entity or an administrator of the data processing system 105 may change or override an initial assignment of a data structure of a policy determined by the assignment model 160.

In some embodiments, the instance assignment 305 can also include an indication of a change in performance (e.g., a positive outcome or a negative outcome). The indication in change in performance can be identified from log data across the set of application instances 130. The data structure may be reassigned to a different application instance 130, and the instance identifier 320 corresponding to the application instance 130 may be recorded as part of the instance assignments 305 to retrain the assignment model 160. With the identification, the model handler 150 may repeat the functionalities as detailed herein to update the one or more weights of the assignment model 160. In this manner, the assignment model 160 can perform self-learning from positive outcomes and negative outcomes from the additional training data. The negative outcomes may include longer transaction times for processing, increased lag when access records, high switching between instances increasing traffic, increased outages during system failures. The positive outcomes may correspond to decrease latency, decreased switching between instances, improved response times, and improved resiliency to outages, among others.

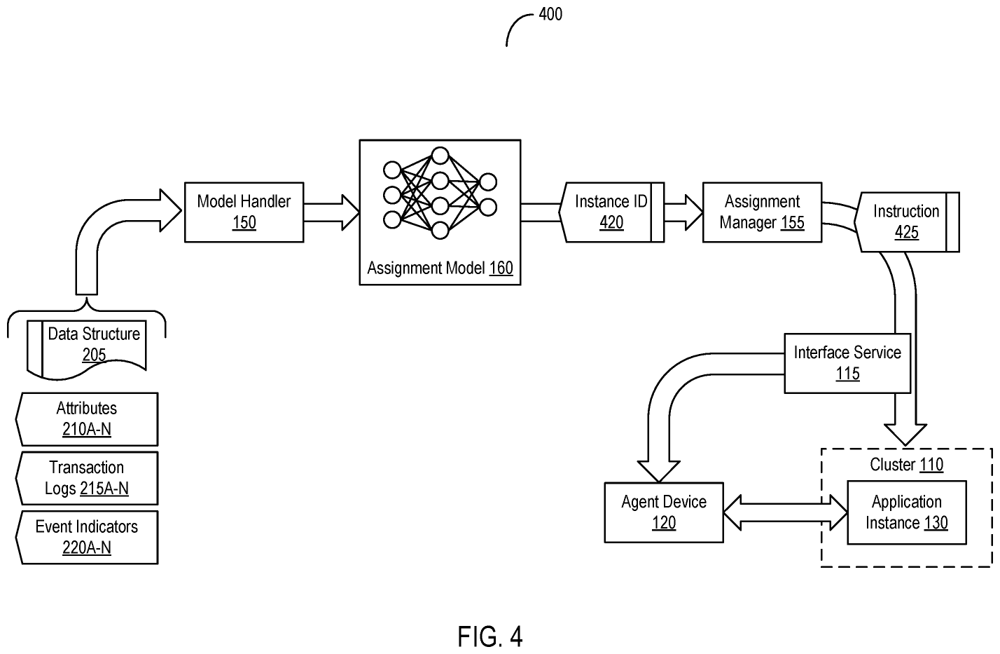

Referring now to FIG. 4, depicted is a block diagram of a process 400 to apply a machine learning model in the system 100 for assigning policies across application instances. The process 400 may include or correspond to operations performed in the system 100 for applying the newly obtained data to the assignment model 160. The model handler 150 may retrieve, obtain, or otherwise identify at least one input for the assignment model 160. The input may include the data structure 205 of the policy, the associated set of attributes 210, the transaction logs 215 of the application instances 130, and the event indicators 220, among others. In some embodiments, the input may include the data structure 205 and the set of attributes 210. In some embodiments, the input may include the data structure 205, the set of attributes 210, and the transaction logs 215. In some embodiments, the input may include the data structure 205, the set of attributes 210, and the event indicators 220. In some embodiments, the input may include input from the request (e.g., from the agent device 120 or the end-user device).

With the identification, the model handler 150 may apply the assignment model 160 to the new input (e.g., the set of attributes 210, the transaction log 215, or the event indicators 220, input from request, or the prompt, or any combination thereof). Upon inputting, the model handler 150 may process the input in accordance with the set of weights of the assignment model 160. From processing, the model handler 150 may create, produce, or otherwise generate an output including a predicted instance identifier 420 corresponding to at least one of the application instances 130. In some embodiments, the output may include at least one predicted performance metric. In some embodiments, the output may include a set of instance identifiers 420 for the corresponding set of application instances 130. The set of instance identifiers 420 may be ranked by the respective predicted performance metrics. In some embodiments, the output may include text identifying the predicted instance identifier 420 corresponding to the application instance 130. In some embodiments, the output text may also include the predicted performance metric for the application instance 130.

The assignment manager 155 executing on the data processing system 105 may assign the data structure 205 to the application instance 130 corresponding to the instance identifier 420 from the assignment model 160. In some embodiments, the assignment manager 155 may identify or select the application instance 130 from the application instances 130 corresponding to the set of instance identifiers 420 based on the predicted performance metric. For instance, the assignment manager 155 may select the application instance 130 corresponding to the highest predicted performance metric. In some embodiments, the assignment manager 155 may assign the data structure 205 to the application instance 130 associated with a location. The location may be the same or different from the location identified in the event indicator 220. For example, the event indicator 220 may identify an occurrence of a tornado in Missouri, and the set of instance identifiers 420 may identify application instances 130 in Missouri and Iowa adjacent to the state.

In some embodiments, the assignment manager 155 may reassign the data structure 205 from the initially assigned application instance 130 to the application instance 130 identified by the instance identifier 420. In some embodiments, the assignment manager 155 may assign the data structure 205 to the application instance 130 associated with the agent entity. For example, the attributes 210 may indicate that a holder of the policy resides in Indiana or that the agent entity assigned to the holder of the policy resides in Wisconsin. The application instance 130 assigned to the data structure 205 of the policy may be physically located in Wisconsin. In some embodiments, the assignment manager 155 may parse the textual output from the assignment model 160 to extract or identify the instance identifier 420. The parsing may be in accordance with a natural language processing (NLP) algorithm, such as information extraction (IE), named entity recognition (NER), relation extraction, or question answering, among others.

With the assignment, the assignment manager 155 may produce, create, or otherwise generate at least one instruction 425. The instruction 425 may include or identify the data structure 205 of the policy and the instance identifier 420 referencing the application instance 130 to which the data structure 205 is assigned. The instruction 425 may include computer readable instructions (e.g., a script or command) to assign the data structure 205 to the application instance 130. The assignment manager 155 may transmit, send, or otherwise provide the instruction 425 to the application instance 130 (or the cluster 110 supporting or hosting the application instance 130). In some embodiments, the assignment manager 155 may provide the instruction 425 to the interface service 115. The interface service 115 in turn may forward, send, or otherwise provide the instruction 425 from the assignment manager 155 to the application instance 130 (or the cluster 110). The assignment manager 155 may store and maintain the assignment of the data structure 205 to the application instance 130 on the database 125. For instance, the assignment manager 155 can store and maintain an association between the policy identifier for the policy associated with the data structure 205 and an identifier for the application instance 130 on the database 125.

In some embodiments, the assignment manager 155 may calculate, identify, or otherwise determine a current performance metric of the application instance 130 assigned to the data structure 205. The determination of the current performance metric may be separate from the predicted performance metric outputted by the assignment model 160. The current performance metric may be based on a volume (or number) of data structures assigned to the application instance 130. The current performance metric may indicate utilization of resources, such as processor usage, memory usage, a number of functions, and network throughput, among others, at the application instance 130.

Based on the current performance metric, the assignment manager 155 may calculate or determine hardware resources to be allocated to the application instance 130 to process the data structure 205. The hardware resources may include processor resources, memory space, and network bandwidth, among others. The amount of hardware resources to be allocated may be as a function of the current performance metric. In some embodiments, the assignment manager 155 may compare the current performance metric with a threshold value. The threshold value may delineate, identify, or otherwise define a value for the performance metric at which additional hardware resources are to be allocated. If the performance metric is below the threshold, the assignment manager 155 may allocate the determined hardware resources. Otherwise, if the performance metric is above the threshold, the assignment manager 155 may maintain the allocation of the hardware resources.

With the receipt of the instruction 425, the application instance 130 may process or parse the instruction 425 to extract or identify the data structure 205 of the policy. The application instance 130 may store and maintain the data structure 205 (e.g., on a local database or storage). The application instance 130 can manage and use the data structure 205 in any number of operations. In some embodiments, the application instance 130 may process data related to the policy corresponding to the data structure 205. In some embodiments, the application instance 130 may process an insurance claim in accordance with the specification of the policy as defined by the data structure 205. The claim may be, for example, an insurance claim for coverage of a loss or damage to an insured asset. For instance, the application instance 130 may identify or determine whether the claim satisfies the conditions of the policy as defined by the data structure 205. When the claim satisfies the condition, the application instance 130 may initiate transfer of a specified value from the insurer to the policy holder. Otherwise, when the claim does not satisfy the condition, the application instance 130 may return, send, or otherwise provide an indication of rejection of the claim.

The interface service 115 (or the assignment manager 155) may facilitate communications between the agent device 120 and the application instance 130 assigned to the data structure 205 of the policy. In some embodiments, the interface service 115 may retrieve, identify, or otherwise receive a request to access one of the application instances 130 from the agent device 120. The request may identify or include an identifier of the agent entity associated with the agent device 120. Based on the request, the interface service 115 may find, select, or otherwise identify the application instance 130 for the agent entity. With the identification, the interface service 115 may assign the agent device 120 to the application instance 130. The interface service 115 may send, transmit, or otherwise provide information associated with the policy defined by the data structure 205 to the agent device 120. The agent device 120 may present the information via an interface (e.g., a graphical user interface) of the application instance 130. Using the interface, the agent entity may handle the processing of data related to the policy.

In this manner, the data processing system 105 may dynamically adjust the assignment of data structures 205 of policies. The data processing system 105 may distribute the data structures of policies across multiple application instances 130 at various clusters 110 to perform load balancing optimized over a multitude of factors, such as the attributes 210, transaction logs 215, and the event indicators 220. Relative to the static, rule-based approaches, the data processing system 105 can use the assignment model 160 to dynamically and optimally select application instances 130 based on predicted load. Using training data in the form of instance assignments 305, the assignment model 160 may be trained to deduce and identify patterns, correlations, and other latent features to be used to select the application instance 130 for data structures 205 of policies.

The distribution of data structures 205 in this fashion can evenly distribute the utilization of computing resources (e.g., processor usage, memory consumption, and network bandwidth), thereby improving the performance (e.g., response time and throughput) of the overall set of clusters 110 and the application instances 130 therein. The data processing system 105 can also better predict sudden changes (e.g., spikes or drops) in load for the application instances 130 based on the events. Furthermore, the dynamic allocation of hardware resources may increase scalability of the application instances 130 to handle higher volumes of data structures 205 and other insurance-related data.

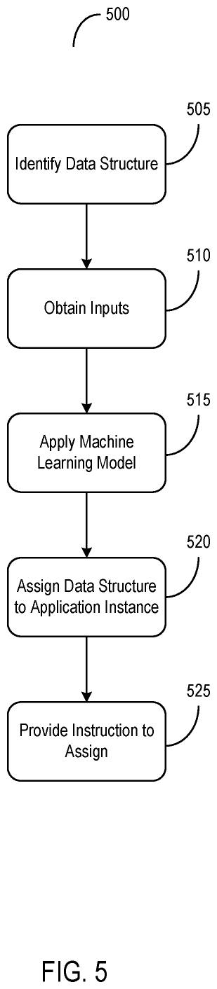

Referring now to FIG. 5, depicted is a flow diagram of a method 500 assigning policies across application instances using machine learning (ML) models. The method 500 may be performed by or implemented using any one or more components detailed herein, such as the system 100 or the system 600 of Section B. In brief overview, under the method 500, one or more processors may identify a data structure (505). The one or more processors may obtain a set of inputs (510). The one or more processors may apply a machine learning model (515). The one or more processors may assign the data structure to an application instance (520). The one or more processors may provide an instruction to assign (525).

In further detail, one or more processors may retrieve, receive, or otherwise identify a data structure (505). The data structure may be for a corresponding policy. The data structure may identify at least one issuer providing the policy, a holder of the policy, an agent associated with the issuer, a type of insurance, an asset under the insurance, and one or more conditions under which a value is to be transferred from the issuer to the holder of the policy, among others. In some embodiments, the one or more processors may access a database to retrieve the data structure. In some embodiments, the one or more processors may receive the data structure as part of a request to assign to an application instance.

The one or more processors may retrieve, identify, or otherwise obtain a set of inputs (510). The set of inputs may include any information to be used to assign the data structure to an application instance. The set of inputs may include a set of attributes associated with the data structure, a set of transaction logs for corresponding application instances, or a set of event indicators, among others, or any combination thereof. The set of attributes may identify a location associated with the holder of the policy, a location of a covered asset, a type of policy holder, a type of insurance, a type of insured asset, a type of risk or disaster, an agent assigned to handle claims for the policy, or a coverage type, among others. Each transaction log may identify activities performed at the respective application instance over a period of time. The event indicator may identify an occurrence of an event, such as an environment event or weather-related event.

The one or more processors may apply a machine learning model to the set of inputs (515). The machine learning model may be any type of artificial intelligence (AI) algorithm or model, such as an artificial neural network (ANN) 1, a regression model, a support vector machine, random forests, a Bayes network, or a clustering model, among others. To apply, the one or more processors may feed the set of inputs to the machine learning model and may process the inputs in accordance with a set of weights of the machine learning model.

The one or more processors may assign the data structure to an application instance (520). From processing the set of inputs using the machine learning model, the one or more processors may generate an instance identifier corresponding to the application instance to which to assign the data structure. In some embodiments, the one or more processors may generate a set of instance identifiers and a corresponding set of predicted performance metrics. The one or more processors may select at least one of the instance identifiers based on the predicted performance metrics. With the selection, the one or more processors may assign the data structure to the application instance.

The one or more processors may send, transmit, or otherwise provide an instruction to assign (525). The instruction may include the data structure of the policy and the instance identifier referencing the application instance to which the data structure is to be assigned. The one or more processors may send the instruction to the application instance. With receipt of the instruction, the application instance may store and maintain the data structure of the policy.

### B. Computing and Network Environment

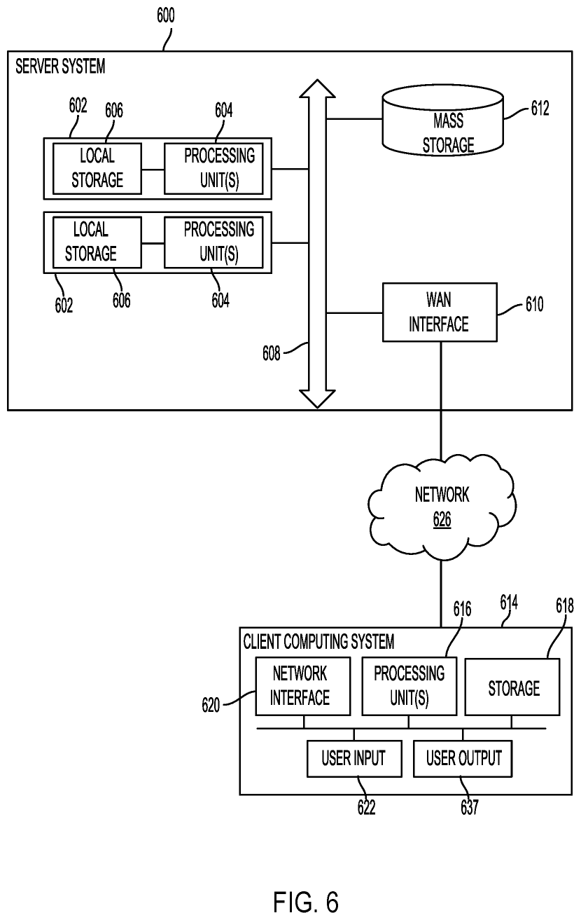

Various operations described herein can be implemented on computer systems. FIG. 6 shows a simplified block diagram of a representative server system 600, client computer system 614, and network 626 usable to implement certain embodiments of the present disclosure. In various embodiments, server system 600 or similar systems can implement services or servers described herein or portions thereof. Client computer system 614 or similar systems can implement clients described herein. The systems 100 described herein can be similar to the server system 600. Server system 600 can have a modular design that incorporates a number of modules 602 (e.g., blades in a blade server embodiment); while two modules 602 are shown, any number can be provided. Each module 602 can include processing unit(s) 604 and local storage 606.

Processing unit(s) 604 can include a single processor, which can have one or more cores, or multiple processors. In some embodiments, processing unit(s) 604 can include a general-purpose primary processor as well as one or more special-purpose co-processors such as graphics processors, digital signal processors, or the like. In some embodiments, some or all processing units 604 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 604 can execute instructions stored in local storage 606. Any type of processors in any combination can be included in processing unit(s) 604.

Local storage 606 can include volatile storage media (e.g., DRAM, SRAM, SDRAM, or the like) and/or non-volatile storage media (e.g., magnetic or optical disk, flash memory, or the like). Storage media incorporated in local storage 606 can be fixed, removable, or upgradeable as desired. Local storage 606 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 604 need at runtime. The ROM can store static data and instructions that are needed by processing unit(s) 604. The permanent storage device can be a non-volatile read-and-write memory device that can store instructions and data even when module 602 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 606 can store one or more software programs to be executed by processing unit(s) 604, such as an operating system and/or programs implementing various server functions such as functions of the system 100 or any other system described herein, or any other server(s) associated with system 100 or any other system described herein.

“Software” refers generally to sequences of instructions that, when executed by processing unit(s) 604, cause server system 600 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 604. Software can be implemented as a single program or a collection of separate programs or program modules that interact as desired. From local storage 606 (or non-local storage described below), processing unit(s) 604 can retrieve program instructions to execute and data to process in order to execute various operations described above.

In some server systems 600, multiple modules 602 can be interconnected via a bus or other interconnect 608, forming a local area network that supports communication between modules 602 and other components of server system 600. Interconnect 608 can be implemented using various technologies, including server racks, hubs, routers, etc.

A wide area network (WAN) interface 610 can provide data communication capability between the local area network (interconnect 608) and the network 626, such as the Internet. Technologies can be used, including wired (e.g., Ethernet, IEEE 802.3 standards) and/or wireless technologies (e.g., Wi-Fi, IEEE 802.11 standards).

In some embodiments, local storage 606 is intended to provide working memory for processing unit(s) 604, providing fast access to programs and/or data to be processed while reducing traffic on interconnect 608. Storage for larger quantities of data can be provided on the local area network by one or more mass storage subsystems 612 that can be connected to interconnect 608. Mass storage subsystem 612 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 612. In some embodiments, additional data storage resources may be accessible via WAN interface 610 (potentially with increased latency).

Server system 600 can operate in response to requests received via WAN interface 610. For example, one of the modules 602 can implement a supervisory function and assign discrete tasks to other modules 602 in response to received requests. Work allocation techniques can be used. As requests are processed, results can be returned to the requester via WAN interface 610. Such operation can generally be automated. Further, in some embodiments, WAN interface 610 can connect multiple server systems 600 to each other, providing scalable systems capable of managing high volumes of activity. Other techniques for managing server systems and server farms (collections of server systems that cooperate) can be used, including dynamic resource allocation and reallocation.

Server system 600 can interact with various user-owned or user-operated devices via a wide-area network such as the Internet. An example of a user-operated device is shown in FIG. 6 as client computing system 614. Client computing system 614 can be implemented, for example, as a consumer device such as a smartphone, other mobile phone, tablet computer, wearable computing device (e.g., smart watch, eyeglasses), desktop computer, laptop computer, and so on.

For example, client computing system 614 can communicate via WAN interface 610. Client computing system 614 can include computer components such as processing unit(s) 616, storage device 618, network interface 620, user input device 622, and user output device 637. Client computing system 614 can be a computing device implemented in a variety of form factors, such as a desktop computer, laptop computer, tablet computer, smartphone, another mobile computing device, wearable computing device, or the like.

Processing unit(s) 616 and storage device 618 can be similar to processing unit(s) 604 and local storage 606 described above. Suitable devices can be selected based on the demands to be placed on client computing system 614; for example, client computing system 614 can be implemented as a “thin” client with limited processing capability or as a high-powered computing device. Client computing system 614 can be provisioned with program code executable by processing unit(s) 616 to enable various interactions with server system 600.

Network interface 620 can provide a connection to the network 626, such as a wide area network (e.g., the Internet) to which WAN interface 610 of server system 600 is also connected. In various embodiments, network interface 620 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 622 can include any device (or devices) via which a user can provide signals to client computing system 614; client computing system 614 can interpret the signals as indicative of particular user requests or information. In various embodiments, user input device 622 can include any or all of a keyboard, touch pad, touch screen, mouse or other pointing device, scroll wheel, click wheel, dial, button, switch, keypad, microphone, and so on.

User output device 637 can include any device via which client computing system 614 can provide information to a user. For example, user output device 637 can include display-to-display images generated by or delivered to client computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that functions as both input and output device. In some embodiments, other user output devices 637 can be provided in addition to or instead of a display. Examples include indicator lights, speakers, tactile “display” devices, printers, and so on.

Some embodiments include electronic components, such as microprocessors, storage, and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 604 and 616 can provide various functionality for server system 600 and client computing system 614, including any of the functionality described herein as being performed by a server or client, or other functionality.

It will be appreciated that server system 600 and client computing system 614 are illustrative and that variations and modifications are possible. Computer systems used in connection with embodiments of the present disclosure can have other capabilities not specifically described here. Further, while server system 600 and client computing system 614 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies, including, but not limited to, specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may refer to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media includes magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method of assigning policies across application instances using machine learning (ML) models, comprising:
identifying, by one or more processors of a policy administration system, a first data structure of a first policy;
obtaining, by the one or more processors, a first plurality of attributes associated with the first policy;
applying, by the one or more processors, a ML model to the first data structure and the first plurality of attributes, wherein the ML model is trained using a plurality of instance assignments, each of the plurality of instance assignments identifying (i) a second data structure of a second policy, (ii) a second plurality of attributes, and (iii) a respective application instance selected from a plurality of application instances based on the second data structure and the second plurality of attributes; and
assigning, by the one or more processors, from applying the ML model, the first data structure of the first policy to a first application instance from the plurality of application instances of the policy administration system.

2. The method of claim 1, further comprising determining, by the one or more processors, a performance metric of the first application instance based on a volume of data structures assigned to the first application instance; and
allocating, by the one or more processors, based on the performance metric, hardware resources to the first application instance to process the first data structure.

3. The method of claim 1, further comprising identifying, by the one or more processors, for each of the plurality of application instances, a first transaction log of activity over a first time period;
wherein applying the ML model further comprises applying the first transaction log for each of the plurality of application instances, wherein each of the plurality of instance assignments identifies, for each corresponding application instance of the plurality of application instances, (i) a respective second transaction log over a second time period and (ii) a respective performance metric identifying a volume of activity subsequent to the second time period, and
wherein assigning the first data structure further comprises selecting the first application instance from the plurality of application instances based on a performance metric determined for the first application instance.

4. The method of claim 1, further comprising receiving, by the one or more processors from a data source, an indication of an environmental event associated with a first location indicated in the first data structure of the first policy,
wherein applying the ML model further comprises applying the ML model to the indication of the environmental event, and
wherein assigning the first data structure further comprises assigning the first data structure to the first application instance associated with at least one of the first location or a second location.

5. The method of claim 1, wherein identifying the first data structure further comprises identifying the first data structure assigned to a second application instance of the plurality application instances, responsive to an indication to change assignment, and
wherein assigning the first data structure further comprises reassigning the first data structure of the first policy from the second application instance to the first application instance.

6. The method of claim 1, further comprising retraining, by the one or more processors, the ML model using a second plurality of instance assignments, wherein the second plurality of instance assignments identifies at least one reassignment of a third data structure of a third policy from a second application instance to a third application instance of the plurality of application instances.

7. The method of claim 1, wherein identifying the first plurality of attributes further comprises identifying the first plurality of attributes including an agent assigned to handle the first policy defined by the first data structure, and
wherein assigning the first data structure further comprises assigning the first data structure of the first policy to the first application instance associated with the agent.

8. The method of claim 1, further comprising:
receiving, by the one or more processors, from a computing device associated with an agent, a request to access at least one of the plurality of application instances;
assigning, by the one or more processors, the computing device to the first application instance based on the request; and
providing, by the one or more processors via an interface of the first application instance, information associated with the first policy defined by the first data structure.

9. The method of claim 1, wherein the first application instance is configured to process data from a holder associated with the first policy, in accordance with the first policy.

10. The method of claim 1, wherein each of the plurality of application instances is supported by at least one of a respective on-premises system or a respective cloud service.

11. A system for assigning policies across application instances using machine learning (ML) models, comprising:
one or more processors coupled with memory, configured to:
identify a first data structure of a first policy;
obtain a first plurality of attributes associated with the first policy;
apply a ML model to the first data structure and the first plurality of attributes, wherein the ML model is trained using a plurality of instance assignments, each of the plurality of instance assignments identifying (i) a second data structure of a second policy, (ii) a second plurality of attributes, and (iii) a respective application instance selected from a plurality of application instances based on the second data structure and the second plurality of attributes; and
assign, from applying the ML model, the first data structure of the first policy to a first application instance from the plurality of application instances of a policy administration system.

12. The system of claim 11, wherein the one or more processors are further configured to:
determine a performance metric of the first application instance based on a volume of data structures assigned to the first application instance; and
allocate, based on the performance metric, hardware resources to the first application instance to process the first data structure.

13. The system of claim 11, wherein the one or more processors are further configured to
identify, for each of the plurality of application instances, a first transaction log of activity over a first time period;
apply the first transaction log for each of the plurality of application instances, wherein each of the plurality of instance assignments identifies, for each corresponding application instance of the plurality of application instances, (i) a respective second transaction log over a second time period and (ii) a respective performance metric identifying a volume of activity subsequent to the second time period; and
select the first application instance from the plurality of application instances based on a performance metric determined for the first application instance.

14. The system of claim 11, wherein the one or more processors are further configured to:
receive, from a data source, an indication of an environmental event associated with a first location indicated in the first data structure of the first policy;
apply the ML model to the indication of the environmental event; and
assign the first data structure to the first application instance associated with at least one of the first location or a second location.

15. The system of claim 11, wherein the one or more processors are further configured to:
identify the first data structure assigned to a second application instance of the plurality application instances, responsive to an indication to change assignment; and
reassign the first data structure of the first policy from the second application instance to the first application instance.

16. The system of claim 11, wherein the one or more processors are further configured to retrain the ML model using a second plurality of instance assignments, wherein the second plurality of instance assignments identifies at least one reassignment of a third data structure of a third policy from a second application instance to a third application instance of the plurality of application instances.

17. The system of claim 11, wherein the one or more processors are further configured to:
identify the first plurality of attributes including an agent assigned to handle the first policy defined by the first data structure; and
assign the first data structure of the first policy to the first application instance associated with the agent.

18. A non-transitory computer readable medium storing instructions, which when executed by at least one processor, cause the at least one processor to:
identify a first data structure of a first policy;
obtain a first plurality of attributes associated with the first policy;
apply a ML model to the first data structure and the first plurality of attributes, wherein the ML model is trained using a plurality of instance assignments, each of the plurality of instance assignments identifying (i) a second data structure of a second policy, (ii) a second plurality of attributes, and (iii) a respective application instance selected from a plurality of application instances based on the second data structure and the second plurality of attributes; and
assign, from applying the ML model, the first data structure of the first policy to a first application instance from the plurality of application instances of a policy administration system.

19. The non-transitory computer readable medium storing instructions of claim 18, wherein the instructions further cause the at least one processor to:
determine a performance metric of the first application instance based on a volume of data structures assigned to the first application instance; and
allocate, based on the performance metric, hardware resources to the first application instance to process the first data structure.

20. The non-transitory computer readable medium storing instructions of claim 18, wherein the instructions further cause the at least one processor to
identify, for each of the plurality of application instances, a first transaction log of activity over a first time period;
apply the first transaction log for each of the plurality of application instances, wherein each of the plurality of instance assignments identifies, for each corresponding application instance of the plurality of application instances, (i) a respective second transaction log over a second time period and (ii) a respective performance metric identifying a volume of activity subsequent to the second time period; and
select the first application instance from the plurality of application instances based on a performance metric determined for the first application instance.
